(19) United States
(12) Patent Application Publication
(10) Pub. No.: US 2017/0204865 A1
(43) Pub. Date: Jul. 20, 2017

(54) EMERGENCY SHUTDOWN SYSTEM FOR TURBINE PUMP ASSEMBLY

(71) Applicant: Hamilton Sundstrand Corporation, Charlotte, NC (US)

(72) Inventor: Richard A. Himmelmann, Beloit, WI (US)

(21) Appl. No.: 14/997,926

(22) Filed: Jan. 18, 2016

(51) Int. Cl. F04D 15/00; F04D 13/04; F04D 1/00; F02K 9/84

(52) U.S. Cl. CPC F04D 15/0066; F02K 9/84; F04D 13/04; F04D 1/00

(57) ABSTRACT

A turbine pump assembly includes a centrifugal pump including an inlet cavity with an inlet pressure, a control section having a turbine flow rate control spool valve, a shut off biasing mechanism located at a first end of the control section, and an inlet pressure piston located at a second end of the control section, and an inlet pressure fluid line fluidly connecting the inlet cavity with the inlet pressure piston. When the inlet pressure is above a predetermined threshold, the inlet pressure is configured to maintain the turbine flow rate control spool valve in an operational mode. When the inlet pressure is below the predetermined threshold, the shut off biasing mechanism is configured to apply a closing force to disable the turbine flow rate control spool valve thereby reducing a speed of a turbine of the turbine pump assembly.

### BACKGROUND

The subject matter disclosed herein generally relates to turbine pump assemblies and, more particularly, to emergency shutdown systems for turbine pump assemblies.

Rockets may be used to launch payloads into space, including inserting payloads into various orbits around the earth or other celestial bodies and/or directing payloads through space. Rockets are maneuvered by vectoring a rocket engine thrust direction. In some configurations, a thrust vector control system may be configured to use hydraulic rams to displace an engine nozzle angle relative to a rocket core axis to control a thrust vector to ensure proper propulsion of a rocket. Hydraulic rams require high pressure hydraulic fluid pumping systems capable of providing, for example, up to 4000 psia at flow rates of 40-100 gallons per minute or greater.

In some systems, the hydraulic flow and pressure may be generated by a turbine pump assembly. The turbine pump assemblies may be powered by hot combustion products, or high pressure cold gas provided by a main engine turbo-pump assembly. Some systems may be configured with a turbine shaft, idler shaft, and output shaft, with a turbine rotational speed controlled by a turbine speed control valve. The turbine speed control valve may operate at speeds that are less than the turbine and may be configured to control flow of fluids to the turbine. In some configurations, the turbine speed control valve may be configured as a flyweight governor actuated spool valve.

Typically, a turbine pump assembly turbine may operate most efficiently at very high rpm (e.g., 115,000 rpm). This is in contrast to a positive displacement hydraulic pump which may operate at significantly lower speeds (e.g., 6100 rpm). To accommodate the differences in operating speed between the turbine and the positive displacement hydraulic pump, a gear reduction system may be incorporated between the positive displacement hydraulic pump and the turbine. For example, a gear reduction system may be utilized to reduce the turbine operating speed (115,000 rpm) down to the positive displacement hydraulic pump operating speed (6100 rpm). The gear reduction system must be geared properly and must be robust enough to transfer power to both the positive displacement hydraulic pump and the valve mechanically linked thereto. Such systems may be large, complex, and expensive.

Such conventional methods and systems have generally been considered satisfactory for their intended purposes. However, improved systems and particularly improved turbine pump assembly systems may provide cost, efficiency, weight, and/or other benefits.

### SUMMARY

According to one embodiment, a turbine pump assembly is provided. The assembly includes a centrifugal pump including an inlet cavity with an inlet pressure, a control section having a turbine flow rate control spool valve, a shut off biasing mechanism located at a first end of the control section, and an inlet pressure piston located at a second end of the control section, and an inlet pressure fluid line fluidly connecting the inlet cavity with the inlet pressure piston. When the inlet pressure is above a predetermined threshold, the inlet pressure is configured to maintain the turbine flow rate control spool valve in an operational mode. When the inlet pressure is below the predetermined threshold, the shut off biasing mechanism is configured to apply a closing force to disable the turbine flow rate control spool valve thereby reducing a speed of a turbine of the turbine pump assembly.

In addition to one or more of the features described above, or as an alternative, further embodiments of the assembly may include a valve opening biasing mechanism operably connected between the inlet pressure piston and the turbine flow rate control spool valve.

In addition to one or more of the features described above, or as an alternative, further embodiments of the assembly may include a biasing mechanism sleeve configured to house the valve opening biasing mechanism and configured in contact with the inlet pressure piston.

In addition to one or more of the features described above, or as an alternative, further embodiments of the assembly may include an adjusting mechanism attached to the inlet pressure piston and in contact with the biasing mechanism sleeve.

In addition to one or more of the features described above, or as an alternative, further embodiments of the assembly may include a stop shoulder located between the inlet pressure piston and the turbine flow rate control spool valve.

In addition to one or more of the features described above, or as an alternative, further embodiments of the assembly may include a sensor port located in fluid communication with the inlet cavity, the inlet pressure fluid line connected to the sensor port.

In addition to one or more of the features described above, or as an alternative, further embodiments of the assembly may include that an inlet pressure cavity is formed between the inlet pressure fluid line and the inlet pressure piston, the inlet pressure cavity configured to receive fluid from the inlet cavity of the centrifugal pump and apply fluid pressure to the inlet pressure piston.

In addition to one or more of the features described above, or as an alternative, further embodiments of the assembly may include that the shut off biasing mechanism is a spring.

In addition to one or more of the features described above, or as an alternative, further embodiments of the assembly may include that the turbine pump assembly is a turbine pump assembly of a rocket.

According to another embodiment, a method of manufacturing a turbine pump assembly is provided. The method includes installing a turbine flow rate control spool valve, a shut off biasing mechanism at a first end, and an inlet pressure piston at a second end, into a control section of a turbine pump assembly and connecting an inlet pressure fluid line between an inlet cavity of a centrifugal pump of the turbine pump assembly and the inlet pressure piston. When an inlet pressure in the inlet cavity is above a predetermined threshold, the inlet pressure is configured to maintain the turbine flow rate control spool valve in an operational mode. When the inlet pressure is below the predetermined threshold, the shut off biasing mechanism is configured to apply a closing force to disable the turbine flow rate control spool valve thereby reducing a speed of a turbine of the turbine pump assembly.

In addition to one or more of the features described above, or as an alternative, further embodiments of the method may include operably connecting the inlet pressure piston with the turbine flow rate control spool valve with a valve opening biasing mechanism.

In addition to one or more of the features described above, or as an alternative, further embodiments of the method may include installing a biasing mechanism sleeve about the valve opening biasing mechanism and configured in contact with the inlet pressure piston.

In addition to one or more of the features described above, or as an alternative, further embodiments of the method may include installing an adjusting mechanism to the inlet pressure piston, the adjusting mechanism in contact with the biasing mechanism sleeve.

In addition to one or more of the features described above, or as an alternative, further embodiments of the method may include forming a stop shoulder located between the inlet pressure piston and the turbine flow rate control spool valve.

In addition to one or more of the features described above, or as an alternative, further embodiments of the method may include connecting the inlet pressure fluid line to a sensor port located in fluid communication with the inlet cavity.

According to another embodiment, a method of operating a turbine pump assembly is provided. The method includes detecting an inlet pressure of an inlet cavity of a centrifugal pump of the turbine pump assembly and applying a closing force to disable a speed control valve when the detected inlet pressure is below a predetermined pressure threshold.

In addition to one or more of the features described above, or as an alternative, further embodiments of the method may include that the detection of the inlet pressure comprises supplying a fluid pressure from the inlet cavity to an inlet pressure piston

In addition to one or more of the features described above, or as an alternative, further embodiments of the method may include that when the inlet pressure is above the predetermined threshold a force is applied to the inlet pressure piston to maintain the speed control valve in an operational mode, and when the inlet pressure falls below the predetermined pressure threshold a closing force is applied to move the speed control valve into a disabled mode.

In addition to one or more of the features described above, or as an alternative, further embodiments of the method may include continuing detecting the inlet pressure and, when the detected inlet pressure is above the predetermined pressure threshold, the speed control valve is enabled.

Technical effects of embodiments of the present disclosure include a turbine pump assembly having a passive automatic shutdown mechanism. Further technical effects include detecting a pressure at an inlet to a centrifugal pump of the turbine pump assembly and using the detected pressure to control the shutdown mechanism automatically.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of a craft that may incorporate embodiments of the present disclosure;

FIG. 1B is an enlarged schematic illustration of a portion of the craft of FIG. 1A;

FIG. 1C is a schematic illustration of a turbine pump assembly for a craft as shown in FIG. 1A;

FIG. 1D is a cross-sectional schematic illustration of the turbine pump assembly of FIG. 1C;

FIG. 2A is schematic illustration of a turbine pump assembly in accordance with an embodiment of the present disclosure;

FIG. 2B is another schematic illustration of the turbine pump assembly of FIG. 2A;

FIG. 2C is an enlarged, cross-sectional schematic illustration of a portion of the turbine pump assembly of FIG. 2A;

FIG. 3 is a flow process for operating a turbine pump assembly in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

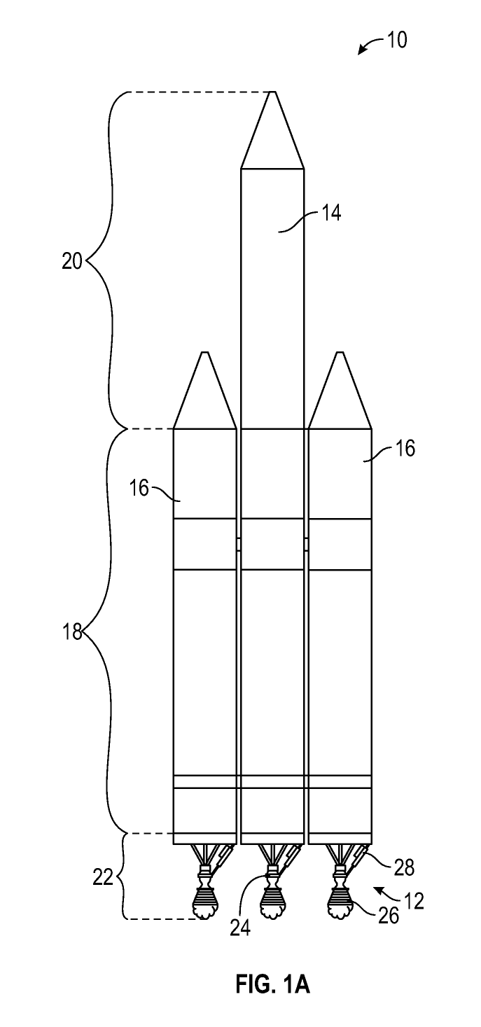

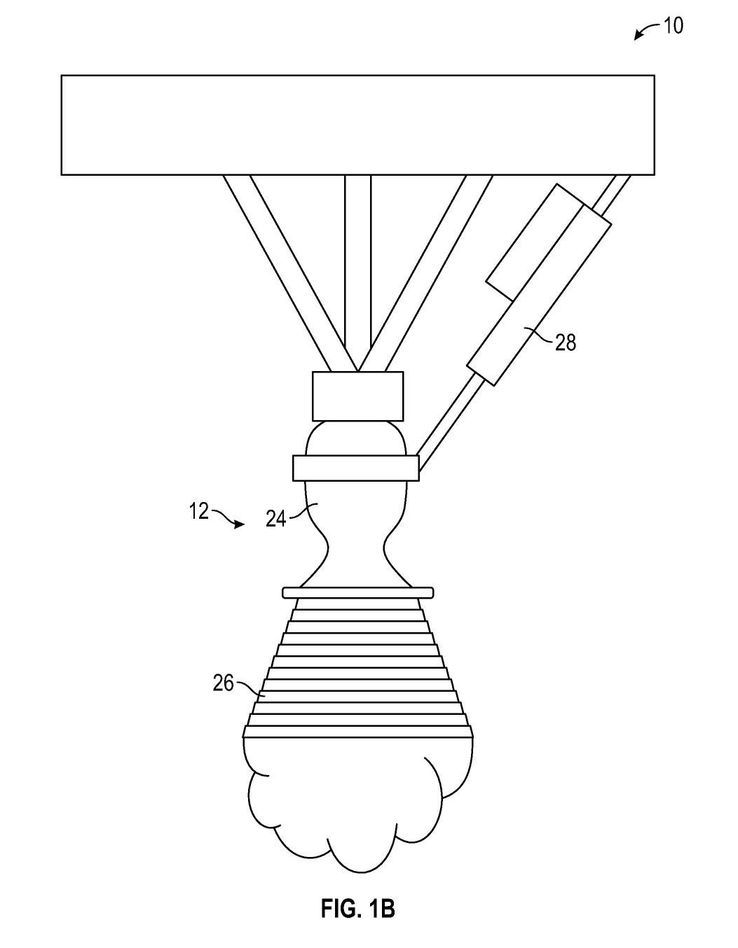

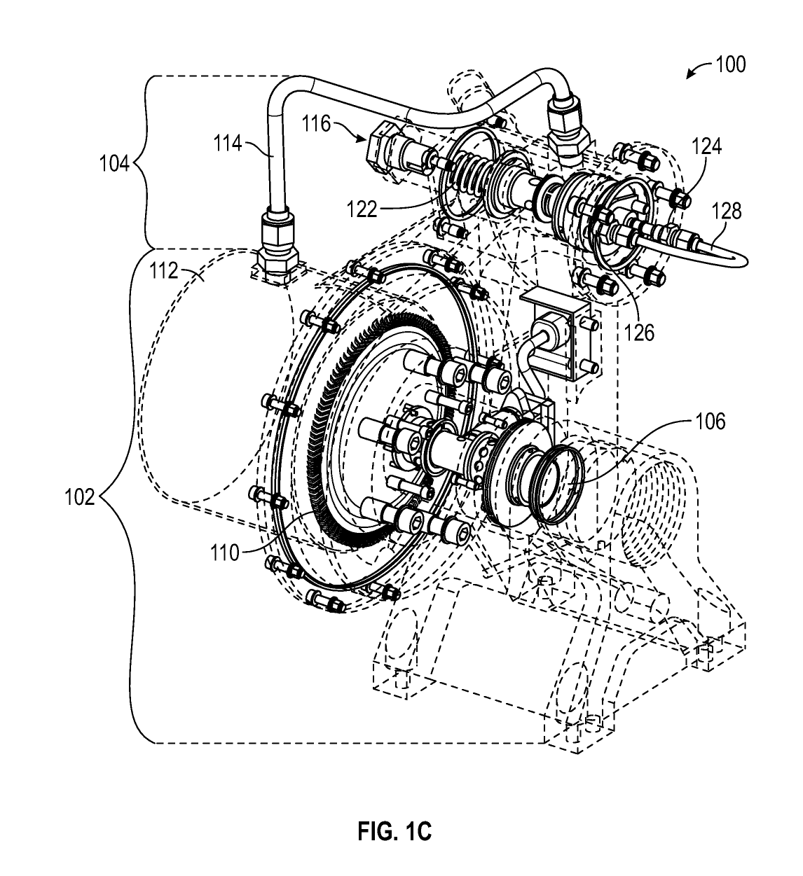

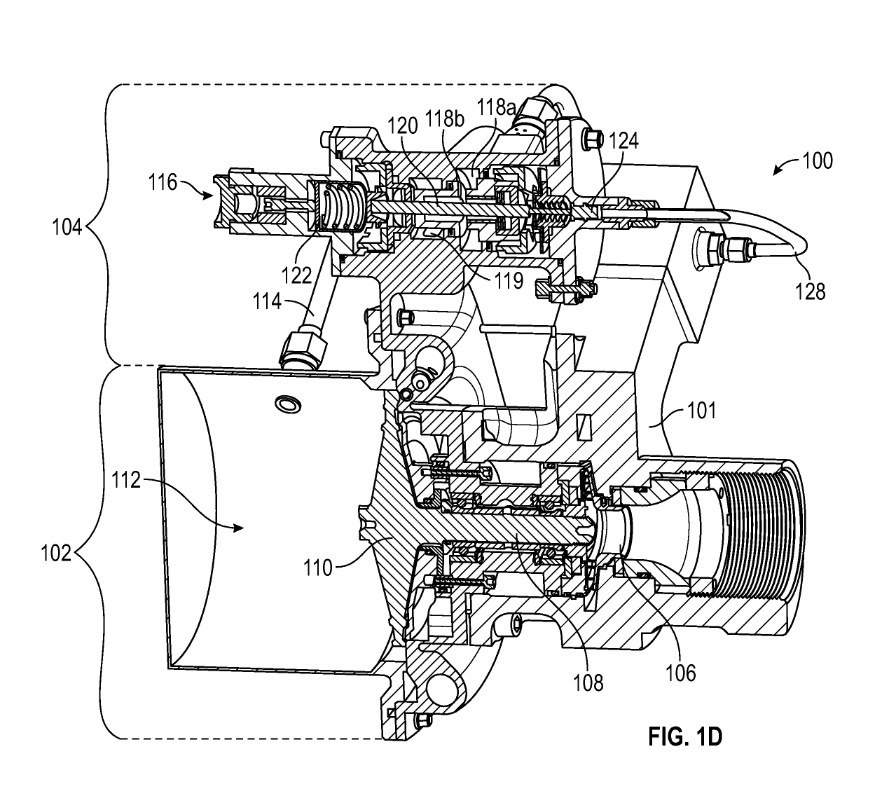

FIGS. 1A-1D show various schematic illustrations of a craft 10 and components thereof. FIGS. 1A and 1B show schematic illustrations of a craft 10 that may be configured to employ embodiments provided herein. FIGS. 1C and 1D show schematic illustrations of a turbine pump assembly 100 for a craft, such as craft 10, that may employ embodiments disclosed herein

FIG. 1A shows a schematic illustration of the craft 10, which may be a rocket or other space craft. FIG. 1B shows an enlarged schematic illustration of the propulsion system 12 of the craft 10. The craft 10 may include a core booster 14 and may also have additional boosters 16. Each booster 14, 16 includes a body portion 18 extending from a nose portion 20 to a tail portion 22. The tail portion 22 includes the propulsion system 12. The propulsion system 12 includes an engine 24 of the booster. The body portions 18 may contain a liquid or solid propellant to fuel the engine 24 of the respective booster 14, 16. The body portion 18 may also be segmented into multiple booster stages, wherein each stage may contain its own engine. The nose portion 20 may contain, but is not limited to, avionics, payload, and crew compartment, etc. depending on the mission and/or configuration of the craft 10.

As shown, the craft 10 may have a propulsion system 12 that may be configured as one or more rocket engines 24. Each engine 24 may be configured with a nozzle 26 that is configured to direct an output of the respective engine 24. The nozzle 26 thus enables directional control of the thrust of the engine 24 and thus the craft 10. That is, depending on the angle of tilt of the nozzle 26, the craft 10 may be propelled in a specific direction. As such, control of the engine 24 and/or nozzle 26 may be paramount to directional control and safety.

Referring now to FIG. 1B, an enlarged schematic illustration of the propulsion system 12 of the craft 10 according to an embodiment of the present disclosure. The engine 24 may include a combustion chamber and a throat with the nozzle 26 configured thereon to direct exhaust from the throat. Fuel from a respective booster (e.g., boosters 14, 16) is fed into the combustion chamber and ignited. The controlled explosion accelerates as it passes through the throat and out the nozzle 26. This controlled explosion creates the thrust required to propel the craft 10. In order to maneuver the craft 10, the thrust may be directed by a thrust vectoring actuator 28, which physically moves, tilts, translates, rotates, directs and/or adjusts the direction or angle of the engine 24 and/or the nozzle 26 to direct the thrust and thus the direction of movement of the craft 10. As will be appreciated by those of skill in the art, there may be two or more thrust vectoring actuators 28 included on the craft 10, with multiple thrust vectoring actuators 28 configured for each engine and/or nozzle. For example, in some embodiments, two thrust vectoring actuators may be positioned about ninety degrees apart to provide pitch and yaw capability to the craft 10. Accordingly, the thrust vectoring actuators 28 may be provided in operational connection with the engine 24 and/or the nozzle 26. In some configurations, the thrust vectoring actuators may incorporate hydraulic actuators and in other configurations the thrust vectoring actuators may incorporate electromechanical actuators.

Thrust vectoring actuators and related control systems may rely on hydraulic rams to displace the engine nozzle angle, relative to a rocket core axis. The hydraulic rams may require high pressure hydraulic fluid pumping systems capable of providing up to 4000 psia at flow rates of up to 40 gpm. The hydraulic flow and pressure may be generated by a turbine pump assembly. The turbine pump assembly can be powered by hot combustion products, or high pressure cold gas provided by the main engine turbo-pump assembly.

For example, with reference to FIGS. 1C and 1D, schematic illustrations of a turbine pump assembly are shown that may employ embodiments disclosed herein. FIG. 1C is a partial isometric view of a turbine pump assembly 100 and FIG. 1D is a cross-sectional view of the turbine pump assembly 100. The turbine pump assembly 100 is a centrifugal pump based turbine pump assembly having a hydraulic speed control that incorporates a high speed turbine directly coupled to a high speed centrifugal pump. The turbine speed is primarily controlled via a hydraulically driven speed control loop. The turbine speed is modulated by the hydraulic discharge pressure of the centrifugal pump to create a relatively constant hydraulic output pressure that is independent of the discharge flow rate of the hydraulic pump.

Thus, with reference to FIGS. 1C and 1D, the turbine pump assembly 100 includes a turbine/pump section 102 and a control section 104. The turbine/pump section 102 includes a high speed centrifugal pump 106 directly coupled to a turbine shaft 108 of a turbine 110 to generate a desired required hydraulic power within a body 101. A turbine exhaust duct 112 is in fluid communication with the control section 104 by a fluid line 114.

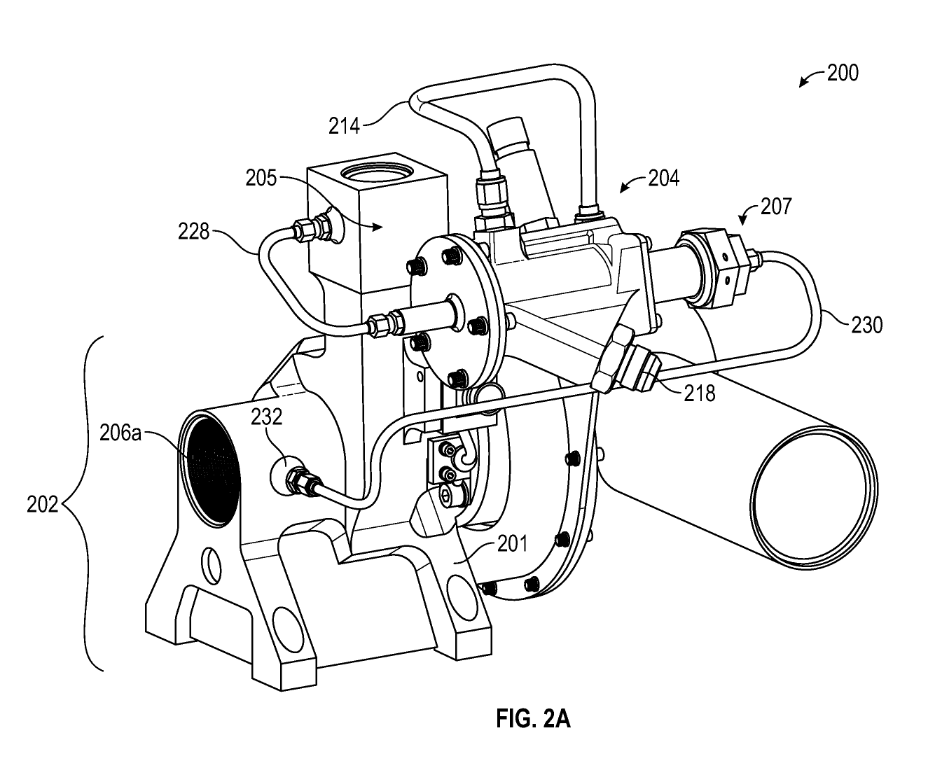

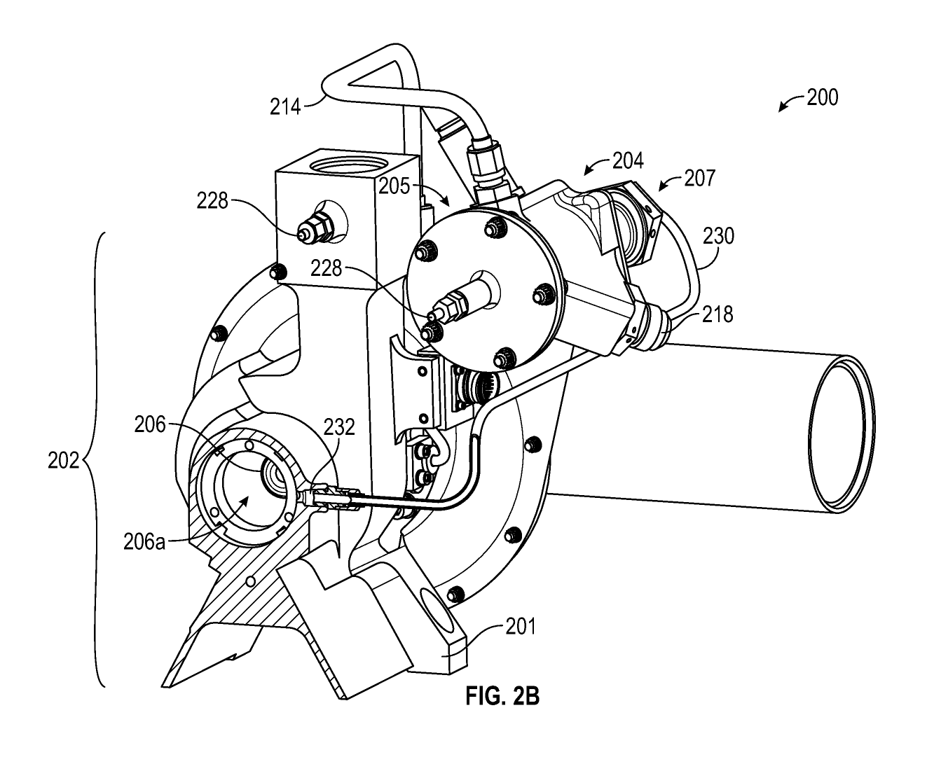

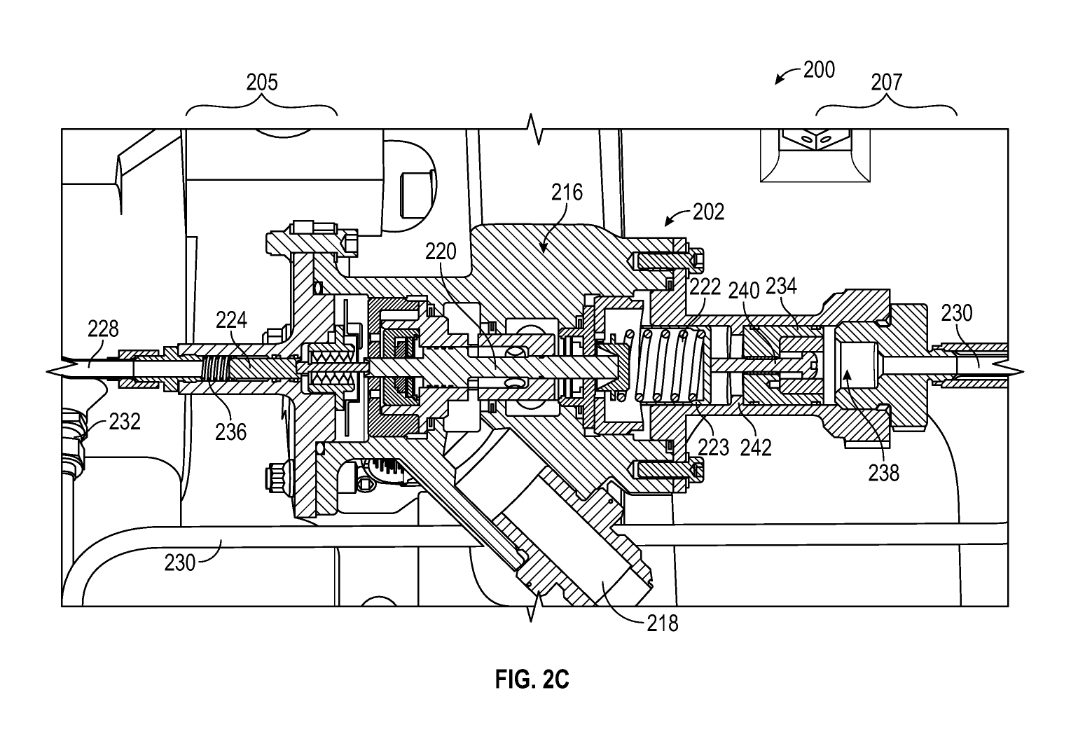

The control section 104 includes a turbine speed control valve 116. A turbine gas inlet port (e.g., as shown in FIG. 2A) may be connected to a valve discharge port, with flow passing through a turbine nozzle housing, a turbine nozzle, the turbine 110, and then into turbine exhaust duct cavity 112. The turbine gas inlet port may be supplied by the rocket or other engine of the craft (e.g., an engine turbo-pump) and/or hot combustion products which may direct high pressure fluid into a first cavity 118a. The gas passes through the turbine control valve 116 (e.g., decreasing the pressure based on the power need of the turbine 110) and then passes through the turbine nozzles where it is expanded (reducing the pressure to exhaust pressure) thereby increasing the gas velocity.

The turbine speed control valve 116 operates by actuation or movement of a turbine flow rate control spool valve 120 which at one end is in operable communication with a valve opening spring 122 and at another end is in operable communication with a hydraulic piston 124. The hydraulic piston 124 may be a speed control hydraulic piston. Accordingly, the hydraulic piston 124 is in operable communication with a hydraulic pressure tap 126 and a hydraulic pressure feedback line 128.

High pressure fluid may enter the control section at a turbine gas inlet port and enter the first cavity 118a. The fluid in the first cavity 118a may be maintained at a high pressure during all operations of use (when the engine is on). The turbine flow rate control spool valve 120 may be moveable within the control section 104 to control fluid flow from the first cavity 118a to a second cavity 118b. Fluid pressure within the second cavity 118b may be controlled by the position of the turbine flow rate control spool valve 120. Further, fluid within the second cavity 118b may flow through an exit 119 to be directed to a nozzle (not shown).

When the turbine pump assembly 100 is at rest, the valve opening spring 122 forces the turbine flow rate control spool valve 120 open. There is no hydraulic pressure to oppose the valve opening spring 122. In this configuration the valve is fully open, allowing a large propellant mass flow rate to flow through turbine gas inlet port into the second cavity 118b. As the turbine 110 accelerates, the output pressure from the centrifugal pump 106 increases, providing a large valve closing force to oppose the valve opening spring 122.

As the discharge flow rate of the centrifugal pump 106 increases, the hydraulic discharge pressure also increases. As this happens, the hydraulic pressure in a cavity proximal to the hydraulic piston 124 increases, increasing a closing force acting on the valve spool 120. This additional closing force drives the valve spool 120 toward the closed position (against the valve opening spring 122), decreasing a propellant mass flow entering the second cavity 118b (and thus propellant gas flow through a nozzle), allowing the turbine 110 to slow down, which decreases the operating speed of the centrifugal pump 106, thereby reducing the discharge pressure of the centrifugal pump 106.

As the discharge flow rate of the centrifugal pump 106 continues to increase, a discharge pressure of the centrifugal pump may begin to decline. As this happens, the hydraulic pressure in the cavity of the hydraulic piston 124 may begin to fall, causing a reduction in the force applied by the hydraulic piston 124. As this happens, the valve opening spring 122 may push the valve spool 120 toward the open position, allowing more mass flow to enter the second cavity 118b and be directed through a nozzle, allowing the speed of the turbine 110 to rise, which may drive the discharge pressure of the centrifugal pump 106 back to a desired value.

Accordingly, in accordance with embodiments provided herein, systems and methods for eliminating catastrophic failure modes associated with a loss of hydraulic pump inlet pressure, which would unload the centrifugal pump of a turbine pump assembly, allowing the turbine to over speed, resulting in a turbine rub or tri-hub burst event.

For example, in some configurations and operations of the turbine pump assembly shown in FIGS. 1A and 1B, if a propellant inlet pressure was set at a nominal condition, and the hydraulic inlet pressure to the centrifugal pump was momentarily reduced below the net positive suction head requirement, the centrifugal pump may cavitate, causing the pump to lose suction. When this happens, the pump discharge pressure may drop, possibly causing the pump to unload, which in turn would remove the mechanical load on a turbine wheel. When this happens, the turbine speed may accelerate until it over speeds resulting in a turbine rub or a tri-hub burst, both of which may cause the turbine pump assembly to cease operation. Systems and methods to passively protect the turbine pump assembly and an associated launch vehicle from a momentary loss of hydraulic inlet pressure are provided herein.

Turning now to FIGS. 2A-2C, schematic views of a turbine pump assembly 200 in accordance with a non-limiting embodiment of the present disclosure are shown. FIG. 2A shows an isometric schematic view of a turbine pump assembly 200 in accordance with an embodiment of the present disclosure. FIG. 2B shows an alternative view of the turbine pump assembly of FIG. 2A. FIG. 2C shows an enlarged cross-sectional schematic view of a control section of the turbine pump assembly 200 of FIG. 2A. The turbine pump assembly 200 is substantially similar to the turbine pump assembly 100 of FIGS. 1A and 1B, and thus similar features may not be described again.

As shown, the turbine pump assembly 200 includes a control section 204 operably connected to a turbine/pump section 202. The turbine/pump section 202 includes a centrifugal pump 206. The centrifugal pump 206 is operably connected to a turbine shaft of a turbine (not shown). A fluid line 214 connects a turbine exhaust duct 212 of the turbine/pump section 202 to the control section 204.

As shown in FIGS. 2A and 2B, a hydraulic pressure feedback line 228 fluidly connects the control section 204 to a portion of the body 201 of the turbine/pump section 202. As shown, the hydraulic pressure feedback line 228 attaches to the control section 204 at a first end 205. The first end 205 may be an end of the control section 204 having a hydraulic piston 224 (see FIG. 2C; see also FIG. 1B, hydraulic piston 124). The hydraulic pressure feedback line 228 may provide fluid communication between the hydraulic piston 224 and a diffuser flow path within the body 201.

As shown in FIGS. 2A and 2B, an inlet pressure fluid line 230 fluidly connects the control section 204 at a second end 207 with the centrifugal pump 206 at a sensor port 232. The sensor port 232 is configured in fluid communication with a centrifugal pump inlet cavity 206a to provide a pump inlet pressure signal to the speed control valve 216 of the control section 204.

Turning to FIG. 2C, an interior, cross-sectional schematic illustration of the control section 204 of the turbine pump assembly 200 is shown. The control section 204 includes a turbine speed control valve 216. A turbine gas inlet port 218 is in fluid communication with a turbine exhaust duct, as described above. The turbine speed control valve 216 operates by actuation or movement of a turbine flow rate control spool valve 220 which at one end (e.g., toward second end 207) is in operable communication with a valve opening biasing mechanism 222 and at another end (e.g., toward first end 205) is in operable communication with a hydraulic piston 224. As shown, the valve opening biasing mechanism 222 may be housed within a biasing mechanism sleeve 223. The hydraulic piston 224 may be a speed control hydraulic piston. The hydraulic piston 224 is configured in operable communication with the hydraulic pressure feedback line 228, with a shut off biasing mechanism 236 located between the hydraulic piston 224 and the hydraulic pressure feedback line 228. The hydraulic pressure feedback line 228 fluidly connects the hydraulic piston 224 to a diffuser flow path formed in the body 201 and in fluid communication with the impeller discharge of the hydraulic pump.

At the second end 207 of the control section 202, the inlet pressure fluid line 230 enables fluid communication from the inlet of the centrifugal pump (through sensor port 232) to an inlet pressure cavity 238. Fluid within the inlet pressure cavity 238 may act upon the inlet pressure piston 234. The inlet pressure piston 234 is in operable communication with the biasing mechanism sleeve 223 by means of an adjusting mechanism 240, such as a screw. The inlet pressure piston 234 and the biasing mechanism sleeve 223 are separated by a stop shoulder 242, with the adjusting mechanism 240 extending from the inlet pressure piston 234 to the biasing mechanism sleeve 223. The inlet pressure piston 234 may be moveable or translatable between the stop should 242 and the inlet pressure fluid line 230.

The valve opening biasing mechanism 222 may bias the spool valve 220 to the left (in FIG. 2C) and the shut off biasing mechanism 236 may bias the spool valve 220 to the right (in FIG. 2C). That is, the valve opening biasing mechanism 222 and the shut off biasing mechanism 236 may bias the spool valve 220 in opposite directions and thus oppose each other. In some embodiments, the biasing force of the valve opening biasing mechanism 222 may be stronger and, in some embodiments, significantly stronger than the biasing force of shut off biasing mechanism 236.

For example, the pump inlet pressure provided through the sensor port 232 provides a static force which may act on the inlet pressure piston 234 (within the inlet pressure cavity 238), causing the inlet pressure piston 234 to translate to the left in FIG. 2C. As the inlet pressure piston 234 moves to the left, the control valve opening biasing mechanism sleeve 223 is translated to the left, compressing the shut off biasing mechanism 236 until the inlet pressure piston 234 contacts the stop shoulder 242.

Once the inlet pressure piston 234 contacts the stop shoulder 242, the speed control valve 216 is in a run mode and functions in normal operation, such as described above. If the hydraulic inlet pressure at the centrifugal pump falls below a pre-determined value, the inlet pressure piston 234 will no longer have the force required to hold the control valve opening biasing mechanism sleeve 223 in a position required for normal operation (e.g., run mode; to the left in FIG. 2C). That is, as the pressure decreases, the shut off biasing mechanism 236 will bias the valve spool 220 to the right in FIG. 2C and the inlet pressure piston 234 will move away from the stop shoulder 242.

As the control valve opening biasing mechanism sleeve 223 moves to the right, a valve opening force exerted on the valve spool 220 will decrease, causing the valve spool 220 to shift to the closed position (i.e., to the right in FIG. 2C), thereby prohibiting the flow of turbine propellant from reaching turbine nozzles and/or turbine wheel. This will cause the turbine speed to reduce, thereby potentially mitigating a failure of the turbine pump assembly. Once hydraulic inlet pressure is re-established (e.g., within the inlet pressure cavity 238), the speed control valve 216 will automatically reconfigure itself to the run mode (e.g., move left in FIG. 2C), allowing the turbine pump assembly 200 to re-start and continue normal operation.

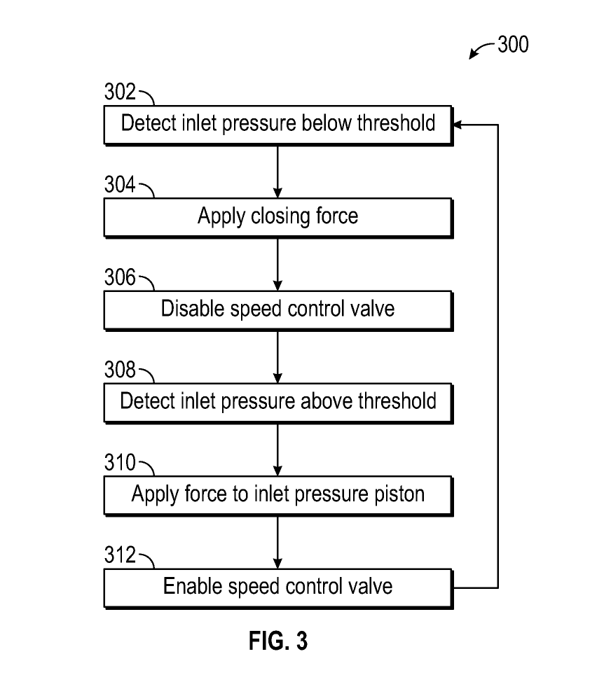

Turning now to FIG. 3, a flow process 300 for operating a turbine pump assembly in accordance with a non-limiting embodiment of the present disclosure is shown. The flow process 300 may be performed by and with a turbine pump assembly as shown and described above.

As shown at block 302, an inlet pressure may be detected below a threshold. The inlet pressure may be a pressure at an inlet to a centrifugal pump of a turbine pump assembly, as described above. The inlet pressure may be detected by enabling fluid communication between an inlet cavity of the centrifugal pump and an inlet pressure cavity. The inlet pressure cavity may be located within a portion of a control section of the turbine pump assembly. The pressure within the inlet pressure cavity may act upon an inlet pressure piston that, when sufficient inlet pressure is present, compresses a shut off biasing mechanism. That is, with sufficient inlet pressure in the inlet pressure cavity, the inlet pressure piston maintains the control section in a normal mode of operation. However, the inlet pressure may fall below a threshold, and may be detected as shown at block 302.

When the inlet pressure is below the predetermined threshold, a closing force may be applied by a shut off biasing mechanism, as shown at block 304. That is, when the inlet pressure falls below the predetermined threshold, the shut off biasing mechanism may apply a force to translate the control section from the normal mode of operation to a disabled or stopped mode.

That is, as shown at block 306, the applied closing force (block 304) may be configured to disable a speed control valve. With the speed control valve disabled, flow of fluid (such as turbine propellant) may be prevented from reaching the turbine nozzles and/or a turbine wheel. This may cause the turbine speed to reduce, thus limiting the possibility of damage and/or failure of the turbine pump assembly.

As shown at block 308, the inlet pressure may rise to a level above the predetermined threshold. This may cause a force to be applied to the inlet pressure piston, as shown at block 310. The force applied to the inlet pressure piston (block 310) may force the speed control valve to be enabled, as shown at block 312. As shown, the flow process 300 may be continuously repeated as the inlet pressure is monitored and directly influences the movement of the pistons and/or biasing mechanisms of the control section of the turbine pump assembly. That is, the flow process 300 may be a passive operation such that the turbine pump assembly may automatically disable the speed control valve when inlet pressure at the centrifugal pump is below a predetermined threshold.

Advantageously, embodiments described herein provide a turbine pump assembly that incorporates a high speed turbine, directly coupled to a high speed centrifugal pump. Further, advantageously, various embodiments provided herein may eliminate failure modes of turbine pump assemblies associated with a loss of hydraulic pump inlet pressure. Such loss of pressure may unload the centrifugal pump of the turbine pump assembly, allowing the turbine to over speed, resulting in a turbine rub or tri-hub burst event. Advantageously, in accordance with some embodiments provided herein, such an event may be passively handled by providing a stop/control mechanism to a control section (and associated speed control valve) of the turbine pump assembly. That is, advantageously, one or more biasing mechanisms may be configured to provide biasing forces that operate under predetermined and/or predefined pressure conditions such that the speed control valve may be disabled when inlet pressure at the centrifugal pump drops below the desired/predetermined pressures.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although the biasing mechanism are shown and described as springs, those of skill in the art will appreciate that other types of biasing mechanisms may be employed without departing from the scope of the present disclosure. Further, one specific configuration of the components of a turbine pump assembly, and particularly the control section thereof, is shown and described. However, those of skill in the art will appreciate that the components and features may be arranged in other configurations without departing from the scope of the present disclosure.

Accordingly, the present disclosure is not to be seen as limited by the foregoing description, but is only limited by the scope of the appended claims.

What is claimed is:

1. A turbine pump assembly comprising:
a centrifugal pump including an inlet cavity with an inlet pressure;
a control section having a turbine flow rate control spool valve, a shut off biasing mechanism located at a first end of the control section, and an inlet pressure piston located at a second end of the control section; and
an inlet pressure fluid line fluidly connecting the inlet cavity with the inlet pressure piston,
wherein, when the inlet pressure is above a predetermined threshold, the inlet pressure is configured to maintain the turbine flow rate control spool valve in an operational mode, and
wherein, when the inlet pressure is below the predetermined threshold, the shut off biasing mechanism is configured to apply a closing force to disable the turbine flow rate control spool valve thereby reducing a speed of a turbine of the turbine pump assembly.

2. The turbine pump assembly of claim 1, further comprising a valve opening biasing mechanism operably connected between the inlet pressure piston and the turbine flow rate control spool valve.

3. The turbine pump assembly of claim 2, further comprising a biasing mechanism sleeve configured to house the valve opening biasing mechanism and configured in contact with the inlet pressure piston.

4. The turbine pump assembly of claim 3, further comprising an adjusting mechanism attached to the inlet pressure piston and in contact with the biasing mechanism sleeve.

5. The turbine pump assembly of claim 1, further comprising a stop shoulder located between the inlet pressure piston and the turbine flow rate control spool valve.

6. The turbine pump assembly of claim 1, further comprising a sensor port located in fluid communication with the inlet cavity, the inlet pressure fluid line connected to the sensor port.

7. The turbine pump assembly of claim 1, wherein an inlet pressure cavity is formed between the inlet pressure fluid line and the inlet pressure piston, the inlet pressure cavity configured to receive fluid from the inlet cavity of the centrifugal pump and apply fluid pressure to the inlet pressure piston.

8. The turbine pump assembly of claim 1, wherein the shut off biasing mechanism is a spring.

9. The turbine pump assembly of claim 1, wherein the turbine pump assembly is a turbine pump assembly of a rocket.

10. A method of manufacturing a turbine pump assembly comprising:
installing a turbine flow rate control spool valve, a shut off biasing mechanism at a first end, and an inlet pressure piston at a second end, into a control section of a turbine pump assembly; and
connecting an inlet pressure fluid line between an inlet cavity of a centrifugal pump of the turbine pump assembly and the inlet pressure piston,
wherein, when an inlet pressure in the inlet cavity is above a predetermined threshold, the inlet pressure is configured to maintain the turbine flow rate control spool valve in an operational mode, and
wherein, when the inlet pressure is below the predetermined threshold, the shut off biasing mechanism is configured to apply a closing force to disable the turbine flow rate control spool valve thereby reducing a speed of a turbine of the turbine pump assembly.

11. The method of claim 10, further comprising operably connecting the inlet pressure piston with the bine flow rate control spool valve with a valve opening biasing mechanism.

12. The method of claim 10, further comprising installing a biasing mechanism sleeve about the valve opening biasing mechanism and configured in contact with the inlet pressure piston.

13. The method of claim 12, further comprising installing an adjusting mechanism to the inlet pressure piston, the adjusting mechanism in contact with the biasing mechanism sleeve.

14. The method of claim 10, further comprising forming a stop shoulder located between the inlet pressure piston and the turbine flow rate control spool valve.

15. The method of claim 10, further comprising connecting the inlet pressure fluid line to a sensor port located in fluid communication with the inlet cavity.

16. A method of operating a turbine pump assembly comprising:
detecting an inlet pressure of an inlet cavity of a centrifugal pump of the turbine pump assembly; and
applying a closing force to disable a speed control valve when the detected inlet pressure is below a predetermined pressure threshold.

17. The method of claim 16, wherein the detection of the inlet pressure comprises supplying a fluid pressure from the inlet cavity to an inlet pressure piston

18. The method of claim 17, wherein when the inlet pressure is above the predetermined threshold a force is applied to the inlet pressure piston to maintain the speed control valve in an operational mode, and when the inlet pressure falls below the predetermined pressure threshold a closing force is applied to move the speed control valve into a disabled mode.

19. The method of claim 16, further comprising continuing detecting the inlet pressure and, when the detected inlet pressure is above the predetermined pressure threshold, the speed control valve is enabled.
